(19) United States
(12) Patent Application Publication
(10) Pub. No.: US 2013/0093844 A1
(43) Pub. Date: Apr. 18, 2013

(54) ELECTRONIC APPARATUS AND DISPLAY CONTROL METHOD

(71) Applicant: Eita SHUTO, Tokyo (JP)

(72) Inventor: Eita SHUTO, Tokyo (JP)

(73) Assignee: KABUSHIKI KAISHA TOSHIBA, Tokyo (JP)

(21) Appl. No.: 13/564,629

(22) Filed: Aug. 1, 2012

(30) Foreign Application Priority Data
Oct. 14, 2011 (JP) 2011-227201

(51) Int. Cl. H04N 13/00

(52) U.S. Cl. 348/43; 348/E13.068

(57) ABSTRACT

According to one embodiment, an electronic apparatus includes a format converter, a video composite module, a parallax image generator, and a display image generator. The format converter converts a video frame of a first format in 3D video data into a video frame of a second format, the video frame of the first format including images with a first resolution. The video composite module generates a composite frame by superimposing a 2D video object on the video frame of the second format. The parallax image generator generates parallax images using the composite frame. The display image generator generates a display image by allocating pixels in the parallax images in a predetermined pattern.

### CROSS-REFERENCE TO RELATED APPLICATIONS

This application is based upon and claims the benefit of priority from prior Japanese Patent Application No. 2011-227201, filed Oct. 14, 2011; the entire contents of which are incorporated herein by reference.

### FIELD

Embodiments described herein relate generally to an electronic apparatus which displays a three-dimensional video, and a display control method applied to the apparatus.

### BACKGROUND

In recent years, various electronic apparatuses used to view three-dimensional video have been provided. As one of such electronic apparatuses, an electronic apparatus based on a naked-eye stereoscopic system (naked-eye three-dimensional system) is available. In the naked-eye stereoscopic system, for example, left- and right-eye images (video frames) are displayed on a screen of a liquid crystal display (LCD), and lenses disposed on the LCD control the directions of emission of light rays corresponding to pixels in the images.

On the screen, pixels in the left-eye image and pixels in the right-eye image are allocated in a predetermined order. For example, the pixels in the left-eye image and pixels in the right-eye image are alternately allocated on the screen. The lenses on the LCD control the direction of emission of light rays corresponding to the allocated pixels. Then, a user can perceive a three-dimensional video (stereoscopic video) since he or she views the pixels of the left-eye image with the left eye, and those of the right-eye image with the right eye.

Some electronic apparatuses which display three-dimensional (3D) video can assure a 3D video display region for displaying a 3D video and a two-dimensional (2D) video display region for displaying a 2D video on their screens. For example, an electronic apparatus such as a personal computer assures a region for displaying a 2D video like a desktop screen, and a region for displaying a 3D video (a window of an application program for playing back 3D video data) in the screen.

In the screen, a cursor which indicates a position pointed by a pointing device such as a mouse is also displayed. This cursor is a 2D video object, but it is assumed to point to not only the interior of the desktop screen as the 2D video but also to the interior of the 3D video display region. As described above, in the 3D video display region, the pixels in the left-eye image and pixels in the right-eye image are allocated in the predetermined order on the screen. Pixels corresponding to the cursor in the three-dimensional video display region are allocated on the screen in the same manner as those included in the left- and right-eye images. For this reason, the cursor is unwantedly displayed at a position different from an original position to have a shape different from an original shape. Hence, it may become difficult for the user to properly recognize a 2D video object such as the cursor, which is displayed in the 3D video display region.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing an example of the appearance of an electronic apparatus according to an embodiment.

FIG. 2 is an exemplary block diagram showing an example of the system configuration of the electronic apparatus according to the embodiment.

FIG. 3 is an exemplary view showing an example of a screen displayed by the electronic apparatus according to the embodiment.

FIG. 4 is an exemplary block diagram showing an example of the configuration of a video content playback program executed by the electronic apparatus according to the embodiment.

FIG. 5 is an exemplary view showing an example of a video including a cursor and a video frame in a side-by-side format included in three-dimensional video data used by the electronic apparatus according to the embodiment.

FIG. 6 is an exemplary view showing an example of left- and right-eye images generated using the video shown in FIG. 5.

FIG. 7 is an exemplary view showing an example of a video which is generated by the electronic apparatus according to the embodiment, and includes a cursor and video frame in an interleaved format.

FIG. 8 is an exemplary view showing an example of a video including a cursor and a video frame in a top-and-bottom format included in three-dimensional video data used by the electronic apparatus according to the embodiment.

FIG. 9 is an exemplary view showing an example of left- and right-eye images generated using the video shown in FIG. 8.

FIG. 10 is an exemplary view showing another example of a video which is generated by the electronic apparatus according to the embodiment, and includes a cursor and video frame in the interleaved format.

FIG. 11 is an exemplary view showing an example of a video which is generated by the electronic apparatus according to the embodiment, and includes a cursor and a video frame in which pixels included in parallax images at two viewpoints are allocated in a grid pattern.

FIG. 12 is an exemplary view showing an example of a video including a cursor and a video frame including parallax images at four viewpoints, which are included in three-dimensional video data used by the electronic apparatus according to the embodiment.

FIG. 13 is an exemplary view showing an example of a video which is generated by the electronic apparatus according to the embodiment, and includes a cursor and a video frame in which pixels included in parallax images at four viewpoints are allocated in a grid pattern.

FIG. 14 is an exemplary flowchart showing an example of the procedure of display control processing executed by the electronic apparatus according to the embodiment.

### DETAILED DESCRIPTION

Various embodiments will be described hereinafter with reference to the accompanying drawings.

In general, according to one embodiment, an electronic apparatus includes a format converter, a video composite module, a parallax image generator, and a display image generator. The format converter converts a video frame of a first format in three-dimensional video data into a video frame of a second format, the video frame of the first format including images with a first resolution. The video composite module generates a composite video frame by superimposing a two-dimensional video object on the video frame of the second format. The parallax image generator generates parallax images with a second resolution higher than the first resolution using the composite video frame. The display image generator configured to generate a display image to be displayed on a screen by allocating pixels in the generated parallax images in a predetermined pattern.

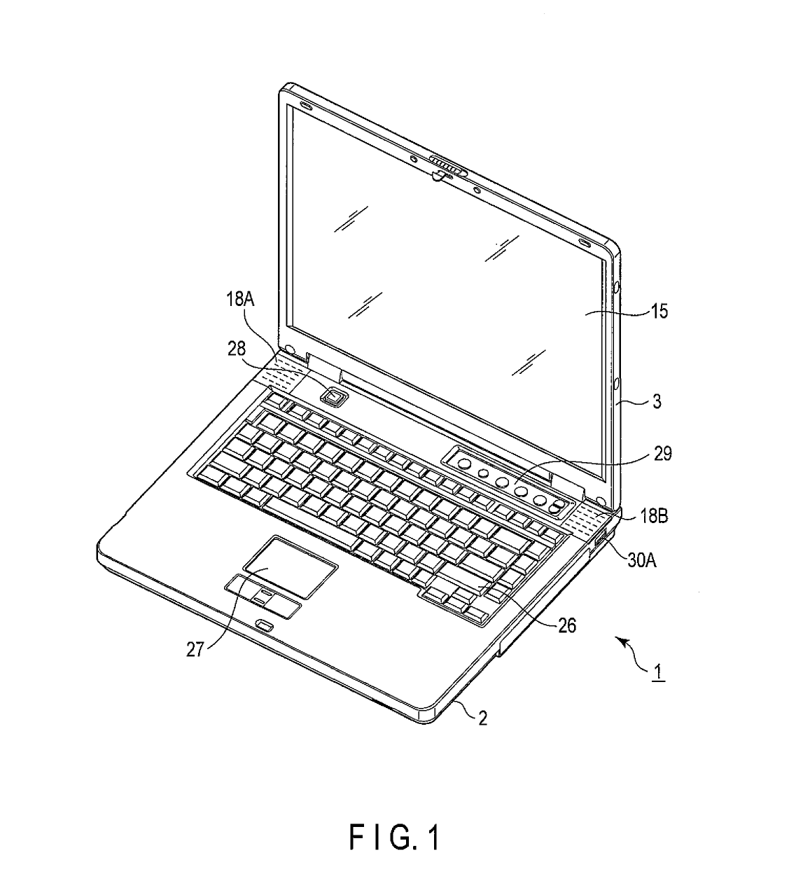

FIG. 1 is a perspective view showing the outer appearance of an electronic apparatus according to an embodiment. This electronic apparatus is implemented as, for example, a notebook type personal computer 1. Alternatively, this electronic apparatus may be implemented as a television receiver, personal video recorder (for example, a hard disk recorder or DVD recorder) for recording and playing back video data, tablet PC, slate PC, PDA, car-navigation system, smartphone, video game machine, and the like.

As shown in FIG. 1, the computer 1 includes a computer main body 2 and display unit 3.

A three-dimensional (3D) display device 15 is built in the display unit 3. The display unit 3 is attached to the computer main body 2 to be freely pivotal between an opening position where the upper surface of the computer main body 2 is exposed and a closing position where the display unit 3 covers the upper surface of the computer main body 2. The 3D display device 15 includes a liquid crystal display (LCD) 15A and lens unit 15B. The lens unit 15B is attached on the LCD 15A. The lens unit 15B include a plurality of lens mechanisms for emitting, in predetermined directions, a plurality of light rays corresponding to a plurality of pixels in an image displayed on the LCD 15A. The lens unit 15B is, for example, liquid crystal gradient index (GRIN) lens which can electrically switch functions required to display a 3D video. With the liquid crystal GRIN lens, a refractive index distribution is generated by electrodes using a flat liquid crystal layer. Hence, for example, a 3D video can be displayed in a designated region of the screen, and a two-dimensional (2D) video can be displayed in the remaining region. That is, by changing the refractive indexes of the lenses between the 3D video display region and the 2D video display region, a 3D video display mode for displaying a 3D video and a 2D video display mode for displaying a 2D video can be locally switched within the screen. In the region set in the 3D video display mode, the refractive indexes are changed, so that a 3D video including left- and right-eye images, which are to be displayed in that region, has parallaxes according to an eye separation distance, viewing distance, and the like. In the region set with the 2D video, the refractive indexes are changed, so that a 2D video to be displayed in that region is displayed intact without being refracted. On the 3D display device 15, each of a plurality of regions which are set within the screen and have arbitrary positions and sizes can be set in either the 3D video mode or 2D video display mode.

The 3D display device 15 displays left- and right-eye images in the region in the 3D video display mode, and displays a 2D video in the region in the 2D video display mode. For this reason, the user can perceive a 3D video when he or she views the region set in the 3D video display mode in the screen, and can perceive a 2D video when he or she views the region set in the 2D video display mode.

The computer main body 2 has a thin box-shaped housing. A keyboard 26, a power button 28 for powering on/off the computer 1, an input operation panel 29, a touchpad 27, speakers 18A and 18B, and the like are disposed on the upper surface of the computer main body 2. On the input operation panel 29, various operation buttons are arranged. These buttons include operation buttons for controlling TV functions (viewing, recording, and playback of recorded broadcast program data/video data).

An antenna terminal 30A for TV broadcast is arranged on, for example, the right side surface of the computer main body 2. Also, an external display connection terminal conforming to, for example, the high-definition multimedia interface (HDMI) standard is arranged on, for example, the back surface of the computer main body 2. This external display connection terminal is used to output video data (moving image data) included in video content data such as broadcast program data to an external display device.

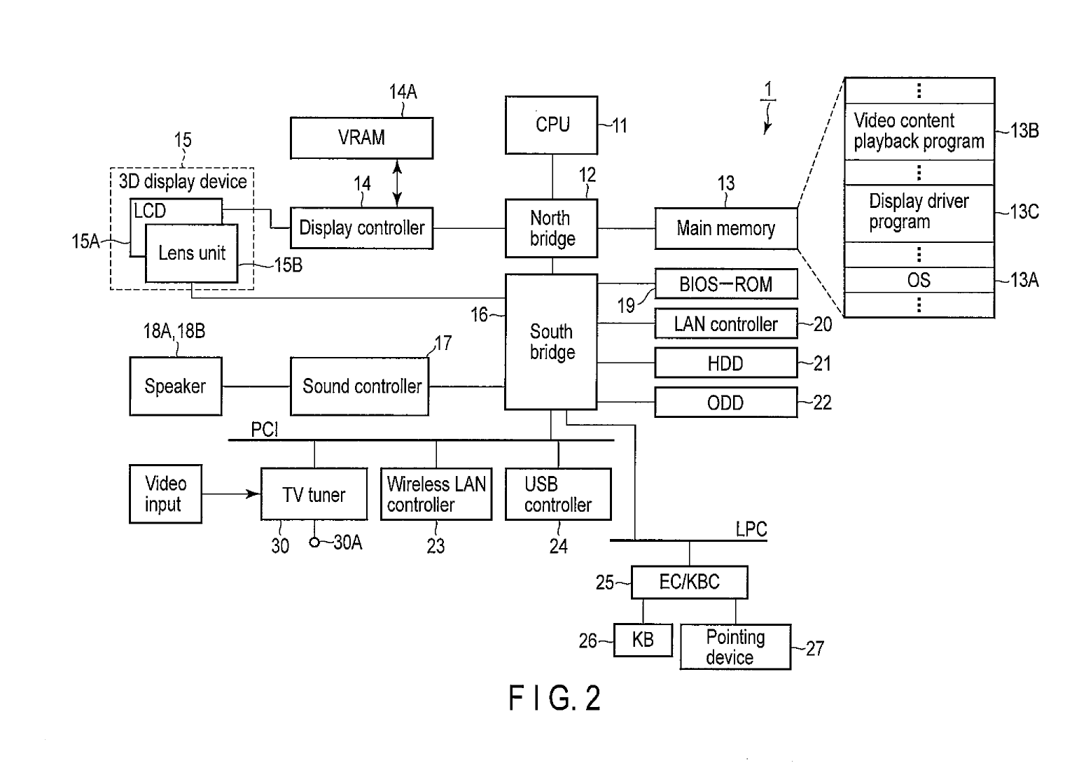

FIG. 2 shows the system configuration of the computer 1.

As shown in FIG. 2, the computer 1 includes a CPU 11, a north bridge 12, a main memory 13, a graphics controller 14, video memory (VRAM) 14A, 3D display device 15, a south bridge 16, a sound controller 17, speakers 18A and 18B, a BIOS-ROM 19, a LAN controller 20, a hard disk drive (HDD) 21, an optical disc drive (ODD) 22, a wireless LAN controller 23, a USB controller 24, an embedded controller/keyboard controller (EC/KBC) 25, keyboard (KB) 26, pointing device 27, a TV tuner 30, and the like.

The CPU 11 is a processor which controls the operation of respective modules in the computer 1. The CPU 11 executes an operating system (OS) 13A, driver programs such as a display driver program 13C, and application programs such as a video content playback program 13B, which are loaded from the HDD 21 onto the main memory 13.

The video content playback program 13B is software having a function for viewing video content data. This video content playback program 13B executes live playback processing for viewing broadcast program data received by the TV tuner 30, video recording processing for recording received broadcast program data in the HDD 21, playback processing for playing back broadcast program data/video data recorded in the HDD 21, playback processing for playing back video content data received via a network, and the like. The video content playback program 13B can also play video content data stored in storage media such as a DVD and BD® and a storage device such as a hard disk.

Furthermore, the video content playback program 13B has a function of viewing a 3D video. The video content playback program 13B displays a 3D video included in video content data (or broadcast program data) to be played back on the screen of the 3D display device 15. More specifically, the video content playback program 13B generates video frames for displaying a 3D video using video content data to be played back. As the format of this video frame, for example, a side-by-side format, top-and-bottom format, or the like is used. A video frame in the side-by-side format is that in which left- and right-eye images are allocated to be juxtaposed in the horizontal direction. The resolution (width) in the horizontal direction of each of the left- and right-eye images in the video frame in the side-by-side format is, for example, half that in the horizontal direction of the video frame. A video frame in the top-and-bottom format is that in which left- and right-eye images are allocated to be juxtaposed in the vertical direction. The resolution (height) in the vertical direction of each of the left- and right-eye images in the video frame in the top-and-bottom format is, for example, half that in the vertical direction of the video frame.

The video content playback program 13B can also convert a 2D video included in video content data into a 3D video in real time, and can display the converted video on the screen. The video content playback program 13B can execute 2D-to-3D conversion of various video content data (for example, broadcast program data, video data stored in the storage media or storage devices, video data received from a server on the Internet, and the like). That is, the video content playback program 13B generates video frames for displaying a 3D video by the 2D-to-3D conversion.

A 3D video is displayed using the 3D display device 15 based on, for example, a stereoscopic system (for example, integral imaging system, lenticular system, parallax barrier system, or the like). The user can perceive a 3D video by the naked eyes by viewing a video displayed on the 3D display device 15 based on the stereoscopic system.

The CPU 11 also executes a Basic Input/Output System (BIOS) stored in the BIOS-ROM 19. The BIOS is a program for hardware control.

The north bridge 12 is a bridge device which connects between a local bus of the CPU 11 and the south bridge 16. The north bridge 12 includes a memory controller which access-controls the main memory 13. Also, the north bridge 12 has a function of communicating with the graphics controller 14.

The graphics controller 14 is a device which controls the LCD 15A that is used as a display of the computer 1. A display signal generated by the graphics controller 14 is supplied to the LCD 15A. The LCD 15A displays a video based on the display signal.

The south bridge 16 controls respective devices on a Peripheral Component Interconnect (PCI) bus and Low Pin Count (LPC) bus. The south bridge 16 includes an Integrated Drive Electronics (IDE) controller for controlling the HDD 21 and ODD 22, and a memory controller which access-controls the BIOS-ROM 19. Furthermore, the south bridge 16 has a function of communicating with the sound controller 17 and LAN controller 20.

Also, the south bridge 16 can output, to the lens unit 15B, a control signal for executing such control as to set each of a plurality of regions in the lens unit 15B in either the 3D video display mode or the 2D video display mode in response to a request from the video content playback program 13B or the like. The lens unit 15B set a target region in either the 3D video display mode or the 2D video display mode by changing, for example, the refractive indexes in liquid crystal layer corresponding to the plurality of regions in accordance with the control signal output from the south bridge 16.

The sound controller 17 is a sound source device, and outputs audio data to be played back to the speakers 18A and 18B. The LAN controller 20 is a wired communication device, which executes wired communications conforming to, for example, the Ethernet® standard. The wireless LAN controller 23 is a wireless communication device, which executes wireless communications conforming to, for example, the IEEE 802.11 standard. The USB controller 24 executes communications with an external device via a cable conforming to, for example, the USB 2.0 standard.

The EC/KBC 25 is a one-chip microcomputer in which an embedded controller for power management and a keyboard controller for controlling the keyboard (KB) 26 and pointing device 27 are integrated. This EC/KBC 25 has a function of powering on/off the computer 1 in accordance with the user's operation.

The TV tuner 30 is a reception device which receives broadcast program data that is broadcast by a television (TV) broadcast signal. The TV tuner 30 is connected to the antenna terminal 30A. This TV tuner 30 is implemented as, for example, a digital TV tuner, which can receive digital broadcast program data of, e.g. terrestrial digital TV broadcasting. Also, the TV tuner 30 has a function of capturing video data output from an external device.

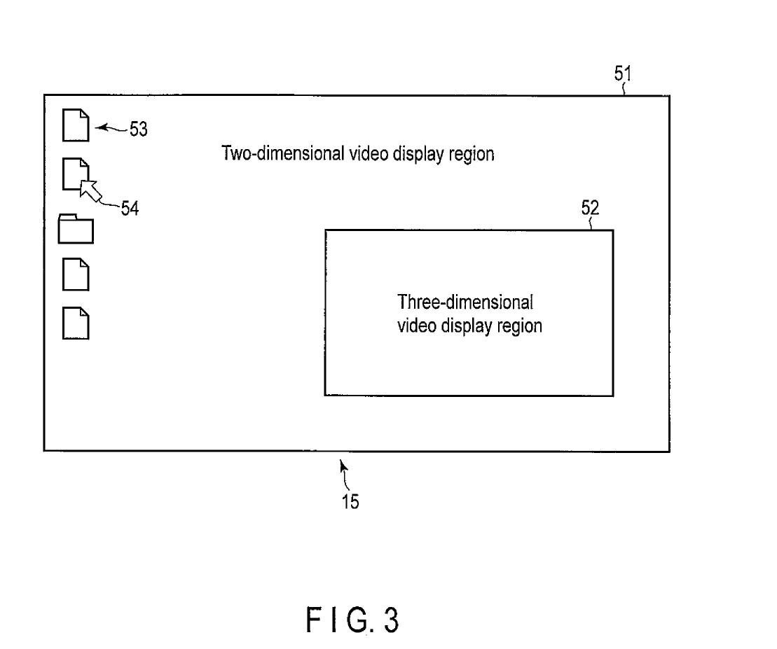

As shown in FIG. 3, a 2D video display region 51 and 3D video display region 52 may be allocated on the 3D display device 15. On the 3D display device 15, 2D video is displayed in the 2D video display region 51, and a video (for example, left- and right-eye images) for displaying a 3D video is displayed in the 3D video display region 52 on the LCD 15A. Then, a part of the lens unit 15B corresponding to the 2D video display region 51 is set in the 2D video display mode, and the other part of the lens unit 15B corresponding to the 3D video display region 52 is set in the 3D video display mode. Thus, the user can perceive 2D video when he or she views the 2D video display region 51, and can perceive a 3D video when he or she views the 3D video display region 52.

In the 2D video display region 51, for example, 2D video 53 of a background, icons, taskbar, toolbar, dialog box, window corresponding to a running application, and the like is displayed. In the 3D video display region 52, for example, a 3D video played back by the video content playback program 13B is displayed. Also, in the 2D video display region 51 and 3D video display region 52, a 2D video such as a cursor (to be also referred to as a 2D video object hereinafter) 54, which indicates a position pointed by the pointing device 27 such as a mouse or touchpad, is displayed. That is, the 2D video object 54 such as the cursor may be displayed not only in the 2D video display region 51 but also in the 3D video display region 52.

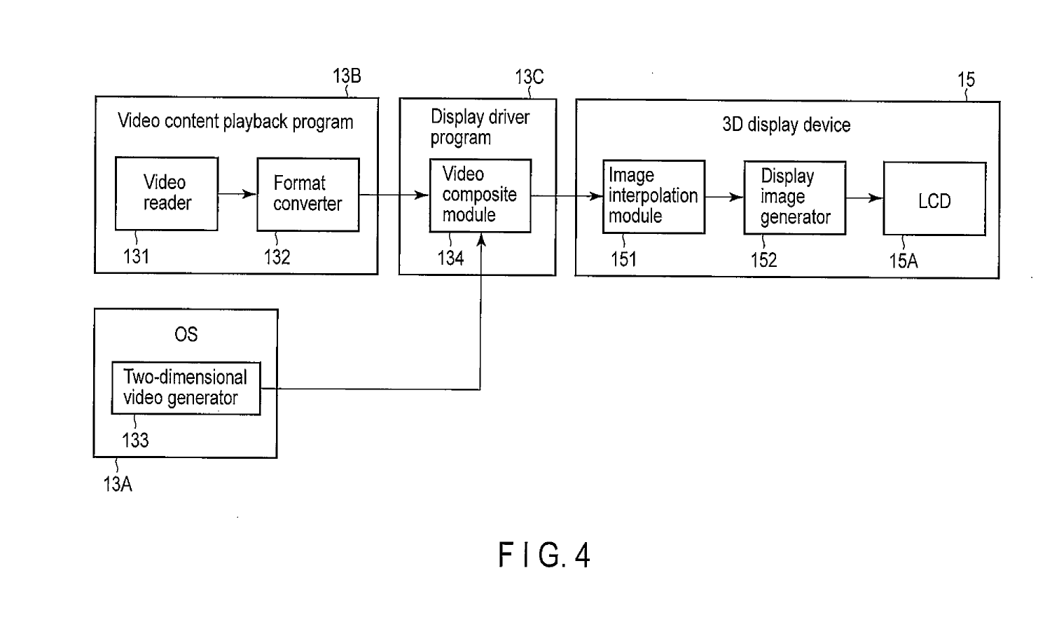

FIG. 4 shows an example of the configuration for displaying 2D video and 3D video on the 3D display device 15. The 3D display device 15 displays a composite video generated by superimposing a first video for displaying 3D video on a second video for displaying 2D video by the display driver program 13C, the first video being generated by the video content playback program 13B, and the second video being generated by the OS 13A.

More specifically, the OS 13A includes a two-dimensional (2D) video generator 133. The 2D video generator 133 generates 2D video (2D video frames) to be displayed in the 2D video display region 51. The 2D video generator 133 generates 2D video 53 of, for example, a background, icons, taskbar, toolbar, dialog box, window corresponding to a running application program, and the like. The 2D video generator 133 also generates the 2D video object 54 such as the cursor, which indicates a position pointed by the pointing device 27 such as a mouse or touchpad. The 2D video generator 133 outputs the generated 2D video 53 and 54 to the display driver program 13C. The 2D video object 54 such as the cursor, the position and size of which is changed on the screen 15, may also be displayed in the 3D video display region 52. Note that other 2D video such as the window is included in the 2D video object 54 if their positions and sizes on the screen 15 can be changed.

The video content playback program 13B includes a video reader 131 and format converter 132.

The video reader 131 reads video content data to be played back from, for example, the HDD 21. The video reader 131 may read video content data from a DVD or BD inserted in the ODD 22. Furthermore, the video reader 131 may receive video content data via a network. The video content data includes, for example, 3D video data corresponding to a plurality of video frames for displaying a 3D video. Each of the plurality of video frames is that in which a plurality of parallax images with a first resolution are allocated based on a first format. More specifically, each of the plurality of video frames is an image in which parallax images (for example, left- and right-eye images) at two viewpoints are allocated in two regions assured in the video frame like in, for example, the side-by-side format or top-and-bottom format (half format). Note that each of the plurality of video frames may be an image in which parallax images corresponding to a larger number of viewpoints may be allocated like an image in which parallax images at four viewpoints are allocated in 2×2 regions, and an image in which parallax images at nine viewpoints are allocated in 3×3 regions.

The video reader 131 sets the plurality of video frames as a target video frame in turn from the first frame. The video reader 131 outputs the target video frame to the format converter 132.

The format converter 132 converts the target video frame from the first format into a second format. For example, the format converter 132 converts the target video frame in the side-by-side format or top-and-bottom format into that in an interleaved format.

More specifically, the format converter 132 detects left- and right-eye images included in the target video frame in, for example, the side-by-side format, and generates a video frame in which pixel lines in the vertical direction included in the left-eye image and pixel lines in the vertical direction included in the right-eye image are alternately allocated (interleaved). Also, the format converter 132 detects left- and right-eye images included in the target video frame in, for example, the top-and-bottom format, and generates a video frame in which pixel lines (scan lines) in the horizontal direction included in the left-eye image and pixel lines in the horizontal direction included in the right-eye image are alternately allocated (interleaved). Then, the format converter 132 outputs the format-converted video frame to the display driver program 13C. Note that the format converter 132 can also convert a video frame generated by the 2D-to-3D conversion into that in the second format.

The display driver program 13C includes a video composite module 134. The video composite module 134 generates a video (composite video frame) by combining 2D video frame output from the 2D video generator 133 and the video frame output from the format converter 132. As described above, the 2D video frame includes images of, for example, a background, icons, taskbar, toolbar, dialog box, window corresponding to a running application, and the like, which are displayed on the screen. The 2D video frame further includes an image (2D video object) such as the cursor which indicates a position pointed by the pointing device 27. The video composite module 134 similarly handles the video frame (the video frame in the second format for displaying 3D video) output from the format converter 132 in the same manner as normal 2D video frame.

The video composite module 134 generates the composite video frame in which 2D video frame is allocated in the 2D video display region 51 and the format-converted video frame is allocated in the 3D video display region 52. Then, the video composite module 134 superimposes the 2D video object on the generated composite video frame. The 2D video object may be superimposed not only in the 2D video display region 51 but also in the 3D video display region 52 depending on a position pointed by the pointing device 27. The video composite module 134 outputs the superimposed video (composite video frame) to the 3D display device 15.

The 3D display device 15 includes an image interpolation module 151 and a display image generator 152.

The image interpolation module 151 generates interpolated parallax images using a video corresponding to the 3D video display region 52 in the composite video frame output from the video composite module 134. The video corresponding to the 3D video display region 52 includes a plurality of regions corresponding to a plurality of parallax images. The image interpolation module 151 generates a plurality of parallax images with a second resolution higher than the first resolution using the plurality of regions corresponding to the plurality of parallax images.

More specifically, in the video corresponding to the 3D video display region 52, pixel lines included in a left-eye image (first image) and pixel lines included in a right-eye image (second image) are alternately allocated in the vertical direction (or horizontal direction). Also, the 2D video object such as the cursor is superimposed (rendered) on these allocated pixel lines.

The image interpolation module 151 detects the pixel lines corresponding to the left-eye image and the pixel lines corresponding to the right-eye image from the video corresponding to the 3D video display region 52. The image interpolation module 151 also detects the 2D video object (a part of the 2D video object) superimposed on the pixel lines corresponding to the left-eye image and the pixel lines corresponding to the right-eye image while regarding it as the pixel lines corresponding to the left-eye image and the pixel lines corresponding to the right-eye image. The image interpolation module 151 generates a left-eye image (that is, a first parallax image with the second resolution) required to display a 3D video on the 3D display device 15 using the pixel lines corresponding to the left-eye image, and also generates a right-eye image (that is, a second parallax image with the second resolution) required to display a 3D video on the 3D display device 15 using the pixel lines corresponding to the right-eye image.

The pixel lines corresponding to the left-eye image (first image) and the pixel lines corresponding to the right-eye image (second image) respectively have a half resolution in the horizontal or vertical direction with respect to the left-eye image (first parallax image) and right-eye image (second parallax image) required to display a 3D video on the 3D display device 15. For this reason, the image interpolation module 151 generates a left-eye image with the second resolution higher than the first resolution (for example, a left-eye image having a double resolution in the horizontal or vertical direction) by interpolating the pixel lines corresponding to the left-eye image with the first resolution. Likewise, the image interpolation module 151 generates a right-eye image with the second resolution (for example, a right-eye image having a double resolution in the horizontal or vertical direction) by interpolating the pixel lines corresponding to the right-eye image with the first resolution. As described above, a part of the 2D video object is superimposed on the pixel lines corresponding to the left-eye image of the first resolution and the pixel lines corresponding to the right-eye image of the first resolution. For this reason, the image interpolation module 151 generates the left-eye image of the second resolution and the right-eye image of the second resolution by also interpolating pixels corresponding to the 2D video object. That is, the image interpolation module 151 generates an extended left-eye image and extended right-eye image using the pixel lines corresponding to the left-eye image and those corresponding to the right-eye image. The image interpolation module 151 outputs the video corresponding to the 2D video display region 51 and the left- and right-eye images for displaying a 3D video in the video output from the video composite module 134 to the display image generator 152.

The display image generator 152 generates a display image to be displayed on the LCD 15A using the video frame corresponding to the 2D video display region 51, and the left- and right-eye images, which are output from the image interpolation module 151. The display image generator 152 generates a display image in which pixels are reallocated in sub-pixel units according to the pixel (sub-pixel) allocation on the LCD 15A using the video frame and images output from the image interpolation module 151. More specifically, the display image generator 152 allocates pixels included in the video frame corresponding to the 2D video display region 51 in corresponding regions (pixels) in the display image. Then, the display image generator 152 allocates pixels included in the left- and right-eye images in a predetermined pattern (a pattern for displaying a 3D video). The display image generator 152 allocates the pixels of the left-eye image in regions (pixels) controlled by the lens unit 15B to be perceived by the left eye, and allocates the pixels of the right-eye image in regions (pixels) controlled by the lens unit 15B to be perceived by the right eye. The display image generator 152 outputs the generated display image to the LCD 15A.

The LCD 15A displays the display image on the screen. Light rays corresponding to pixels in the displayed image are controlled to emit in predetermined directions by the lens unit 15B. Thus, the user can perceive a 2D video displayed in the 2D video display region 51, and a 3D video displayed in the 3D video display region 52. Note that the aforementioned image interpolation module 151 and display image generator 152 may be included in the graphics controller 14 in place of the 3D display device 15.

The format conversion by the format converter 132 will be described below with reference to FIGS. 5, 6, 7, 8, 9, 10, 11, 12, and 13.

FIG. 5 shows an example of a video 61 corresponding to the 3D video display region 52 in the composite video frame generated by the video composite module 134. In the example shown in FIG. 5, assume that the format converter 132 does not convert a video frame for 3D video in the first format into a video frame in the second format. For this reason, the video 61 includes left- and right-eye images 61L and 61R included in the video frame in the side-by-side format (first format), and a 2D video object 541 is superimposed on the right-eye image 61R.

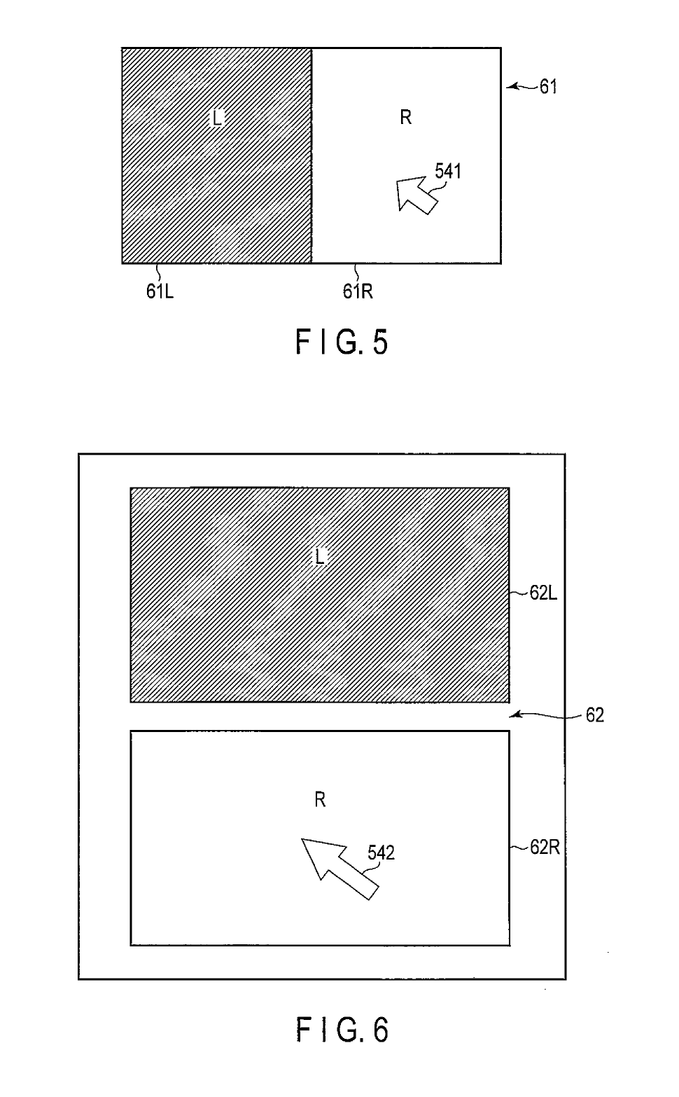

FIG. 6 shows an example in which the image interpolation module 151 generates left- and right-eye images 62L and 62R for displaying a 3D video on the 3D display device 15 using the left-eye image (first image) 61L and right-eye image (second image) 61R. The image interpolation module 151 generates the left-eye image 62L for displaying a 3D video on the 3D display device 15 by extending the left-eye image 61L (by interpolating the left-eye image 61L). Also, the image interpolation module 151 generates the right-eye image 62R for displaying a 3D video on the 3D display device 15 by extending the right-eye image 61R (by interpolating the right-eye image 61R). Then, the display image generator 152 generates a display image to be displayed on the LCD 15A by allocating pixels in the left-eye image 62L and pixels in the right-eye image 62R in a predetermined pattern.

However, since the right-eye image 61R is extended, the size and position of the 2D video object 541 on the video 61 shown in FIG. 5 are different from those of a 2D video object 542 on the right-eye image 62R shown in FIG. 6. For this reason, the 2D video object 541 is not appropriately displayed on the 3D display device 15. Therefore, the user cannot recognize the appropriate position and size of the 2D video object such as the cursor, which is displayed in the 3D video display region 52 on the 3D display device 15, and can no longer use the cursor or the like.

For this reason, in this embodiment, as described above, the format converter 132 converts the video frame for displaying a 3D video from the first format into the second format.

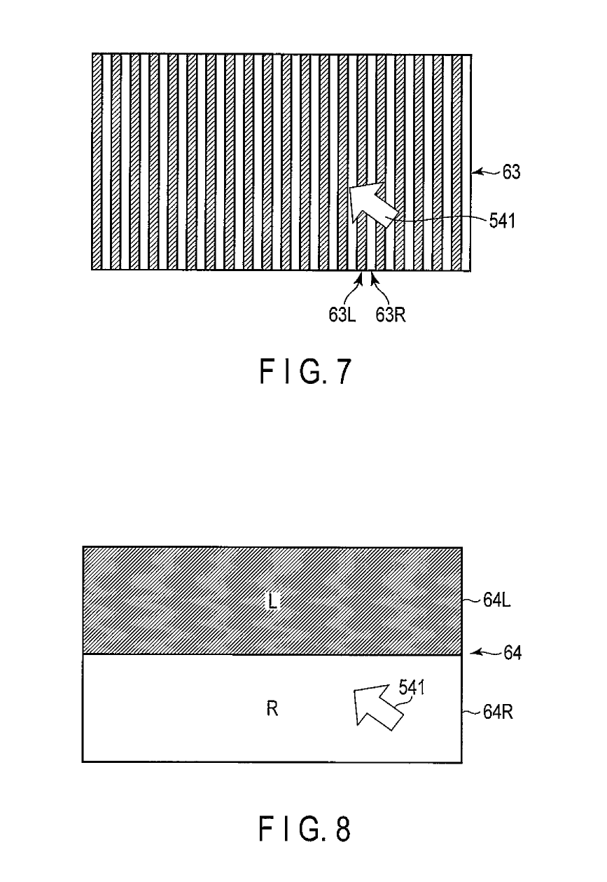

FIG. 7 shows an example in which the video frame in the side-by-side format shown in FIG. 5 is converted into that in the interleaved format by the format converter 132. In a video 63, pixel lines 63L in the vertical direction corresponding to the left-eye image (first image) and pixel lines 63R in the vertical direction corresponding to the right-eye image (second image) are alternately allocated. Then, the 2D video object (cursor) 541 is superimposed on the alternately allocated pixel lines 63L and 63R. For this reason, pixels corresponding to the 2D video object 541 are included in both a region (pixel lines) 63L corresponding to the left-eye image and a region (pixel lines) 63R corresponding to the right-eye image.

The image interpolation module 151 generates a left-eye image (first parallax image) for displaying a 3D video on the 3D display device 15 using the pixel lines 63L corresponding to the left-eye image (first image). The image interpolation module 151 also generates a right-eye image (second parallax image) for displaying a 3D video on the 3D display device 15 using the pixel lines 63R corresponding to the right-eye image (second image). Then, the display image generator 152 generates a display image to be displayed on the LCD 15A by allocating pixels in the generated left-eye image (first parallax image) and pixels in the right-eye image (second parallax image) in a predetermined pattern. Then, the 2D video object 541 such as the cursor, which is displayed in the 3D video display region 52, can be displayed at an appropriate position to have an appropriate size.

In the video 63 in which the left- and right-eye images 61L and 61R are interleaved for respective pixel lines by the format conversion unit 132, a part of the 2D video object 541 is respectively superimposed on the pixel lines 63L of the left-eye image 61L and the pixel lines 63R of the right-eye image 61R. In other words, a part of the 2D video object 541 is omitted on each of the pixel lines 63L of the left-eye image 61L and the pixel lines 63R of the right-eye image 61R. For this reason, in an image which is displayed in the 3D video display region 52 by the 3D display device 15, a part of the 2D video object 541 may seem to be omitted. However, since the 2D video object 541 displayed in the 3D video display region 52 is maintained to have an appropriate position and size, the user can recognize the 2D video object 541 such as the cursor to be located at the original position to have the original size even in the 3D video display region 52. The user can appropriately recognize the cursor 541 since a position pointed by the cursor 541 is free from any displacement.

FIG. 8 shows an example of a video 64 corresponding to the 3D video display region 52 in the composite video frame generated by the video composite module 134. In the example shown in FIG. 8, assume that the format converter 132 does not convert a video frame for a 3D video in the first format into a video frame in the second format. For this reason, the video 64 includes left- and right-eye images 64L and 64R included in a video frame in the top-and-bottom format (first format), and the 2D video object 541 is superimposed on the right-eye image 64R.

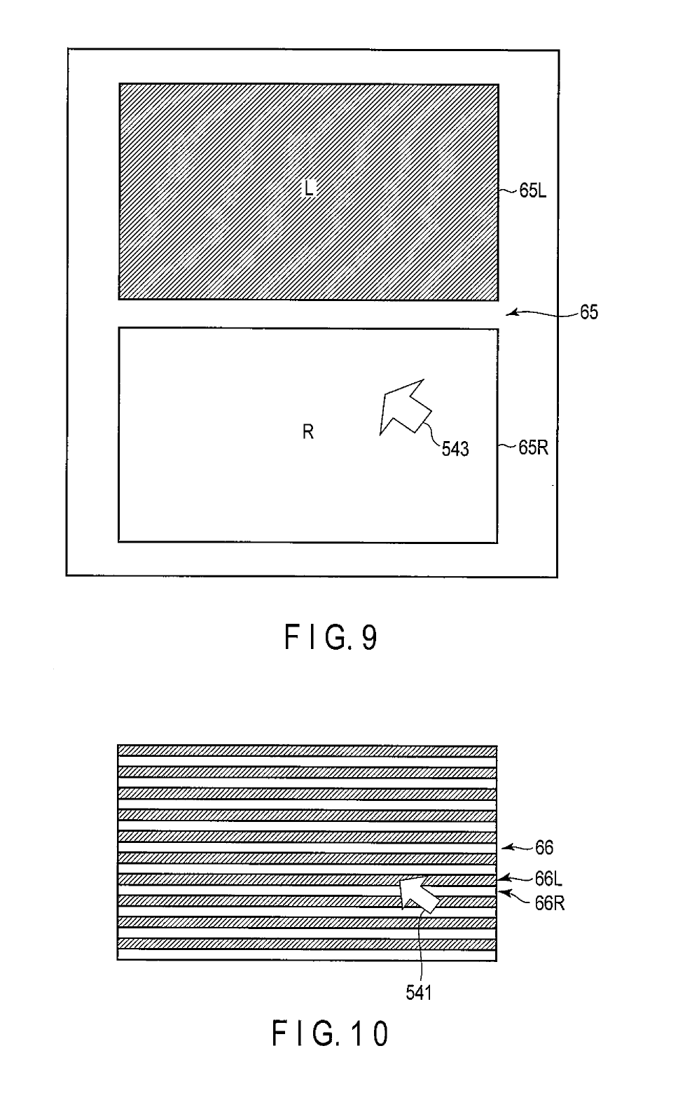

FIG. 9 shows an example in which the image interpolation module 151 generates left- and right-eye images 65L and 65R for displaying a 3D video on the 3D display device 15 using the left-eye image (first image) 64L and right-eye image (second image) 64R. The image interpolation module 151 generates the left-eye image 65L for displaying a 3D video on the 3D display device 15 by extending the left-eye image 64L. Also, the image interpolation module 151 generates the right-eye image 65R for displaying a 3D video on the 3D display device 15 by extending the right-eye image 64R. Then, the display image generator 152 generates a display image to be displayed on the LCD 15A by allocating pixels in the left-eye image 65L and pixels in the right-eye image 65R in a predetermined pattern.

However, since the right-eye image 64R is extended, the size and position of the 2D video object 541 on the video 64 shown in FIG. 8 are different from those of a 2D video object 543 on the right-eye image 65R shown in FIG. 9. For this reason, the 2D video object 541 is not appropriately displayed on the 3D display device 15. Therefore, the user cannot recognize the appropriate position and size of the 2D video object such as the cursor, which is displayed in the 3D video display region 52 on the 3D display device 15, and can no longer use the cursor or the like.

For this reason, in this embodiment, as described above, the format converter 132 converts the video frame for displaying a 3D video from the first format into the second format.

FIG. 10 shows an example in which the video frame in the top-and-bottom format shown in FIG. 8 is converted into that in the interleaved format by the format converter 132. In a video 66, pixel lines 66L in the horizontal direction corresponding to the left-eye image and pixel lines 66R in the horizontal direction corresponding to the right-eye image are alternately allocated. Then, the 2D video object (cursor) 541 is superimposed on the alternately allocated pixel lines 66L and 66R. For this reason, pixels corresponding to the 2D video object 541 are included in both a region (pixel lines) 66L corresponding to the left-eye image and a region (pixel lines) 66R corresponding to the right-eye image.

The image interpolation module 151 generates a left-eye image (first parallax image) for displaying a 3D video on the 3D display device 15 using the pixel lines 66L corresponding to the left-eye image (first image). The image interpolation module 151 generates a right-eye image (second parallax image) for displaying a 3D video on the 3D display device 15 using the pixel lines 66R corresponding to the right-eye image (second image). Then, the display image generator 152 generates a display image to be displayed on the LCD 15A by allocating pixels in the generated left-eye image (first parallax image) and pixels included in the right-eye image (second parallax image) in a predetermined pattern. Then, the 2D video object 541 such as the cursor, which is displayed in the 3D video display region 52, can be displayed at an appropriate position to have an appropriate size.

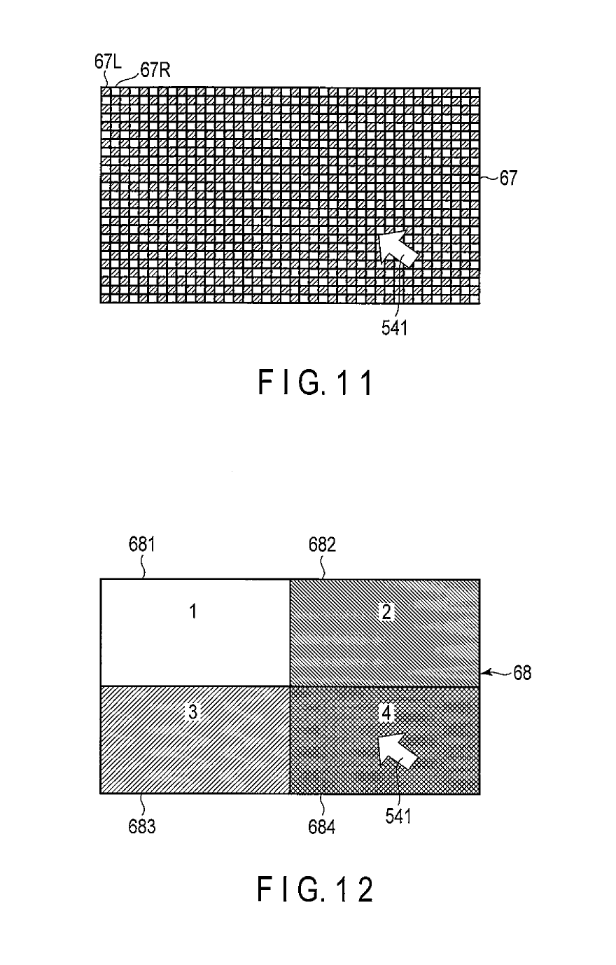

FIG. 11 shows an example in which the video frame shown in FIG. 5 or 8 is converted by the format converter 132 into a format in which pixels are allocated in a grid pattern. In a video 67, pixels 67L in the left-eye image 61L (or 64L) and pixels 67R in the right-eye image 61R (or 64R) are allocated in a grid pattern. Then, the 2D video object (cursor) 541 is superimposed on the pixels 67L and 67R allocated in the grid pattern. For this reason, pixels corresponding to the 2D video object 541 are included in both the pixels 67L corresponding to the left-eye image, and the pixels 67R corresponding to the right-eye image. The image interpolation module 151 generates a left-eye image (first parallax image) for displaying a 3D video on the 3D display device 15 using the pixels 67L corresponding to the left-eye image (first image). The image interpolation module 151 also generates a right-eye image (second parallax image) for displaying a 3D video on the 3D display device 15 using the pixels 67R corresponding to the right-eye image (second image). Then, the display image generator 152 generates a display image to be displayed on the LCD 15A by allocating pixels in the generated left-eye image (first parallax image) and pixels in the right-eye image (second parallax image) in a predetermined pattern. Thus, the 2D video object 541 such as the cursor, which is displayed in the 3D video display region 52, can be displayed at an appropriate position to have an appropriate size.

Note that video content data (3D video data) to be played back may include a video frame including parallax images corresponding to four viewpoints.

FIG. 12 shows an example of a video 68 corresponding to the 3D video display region 52 in the composite video frame generated by the video composite module 134. In the example shown in FIG. 12, assume that the format converter 132 does not convert the format of the video frame for displaying a 3D video. For this reason, the video 68 includes parallax images 681, 682, 683, and 684 corresponding to four viewpoints, and the 2D video object 541 is superimposed on the parallax image 684.

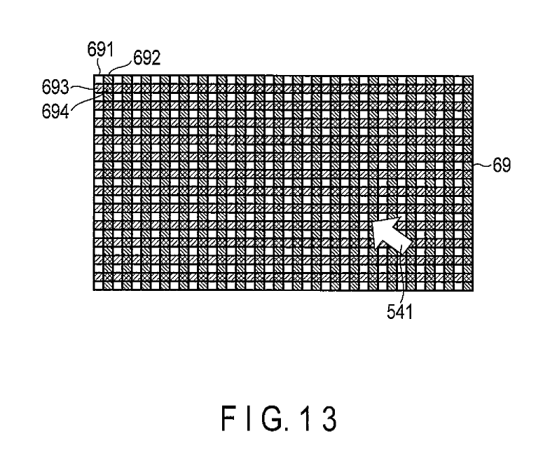

Then, FIG. 13 shows an example in which the video frame shown in FIG. 12 is converted by the format converter 132 into the second format. In a video 69, pixels 691, 692, 693, and 694 respectively included in the parallax images 681, 682, 683, and 684 are allocated in a grid pattern. Then, the 2D video object (cursor) 541 is superimposed on the pixels 691, 692, 693, and 694, which are allocated in the grid pattern. For this reason, pixels corresponding to the 2D video object 541 are included in the pixels 691, 692, 693, and 694 respectively corresponding to the parallax images 681, 682, 683, and 684. The image interpolation module 151 generates a parallax image for displaying a 3D video on the 3D display device 15 using the pixels 691 corresponding to the parallax image 681. The image interpolation module 151 generates a parallax image for displaying a 3D video on the 3D display device 15 using the pixels 692 corresponding to the parallax image 682. The image interpolation module 151 generates a parallax image for displaying a 3D video on the 3D display device 15 using the pixels 693 corresponding to the parallax image 683. The image interpolation module 151 generates a parallax image for displaying a 3D video on the 3D display device 15 using the pixels 694 corresponding to the parallax image 684. Then, the display image generator 152 generates a display image to be displayed on the LCD 15A by allocating pixels respectively included in the generated parallax images in a predetermined pattern. Thus, the 2D video object 541 such as the cursor, which is displayed in the 3D video display region 52, can be displayed at an appropriate position to have an appropriate size.

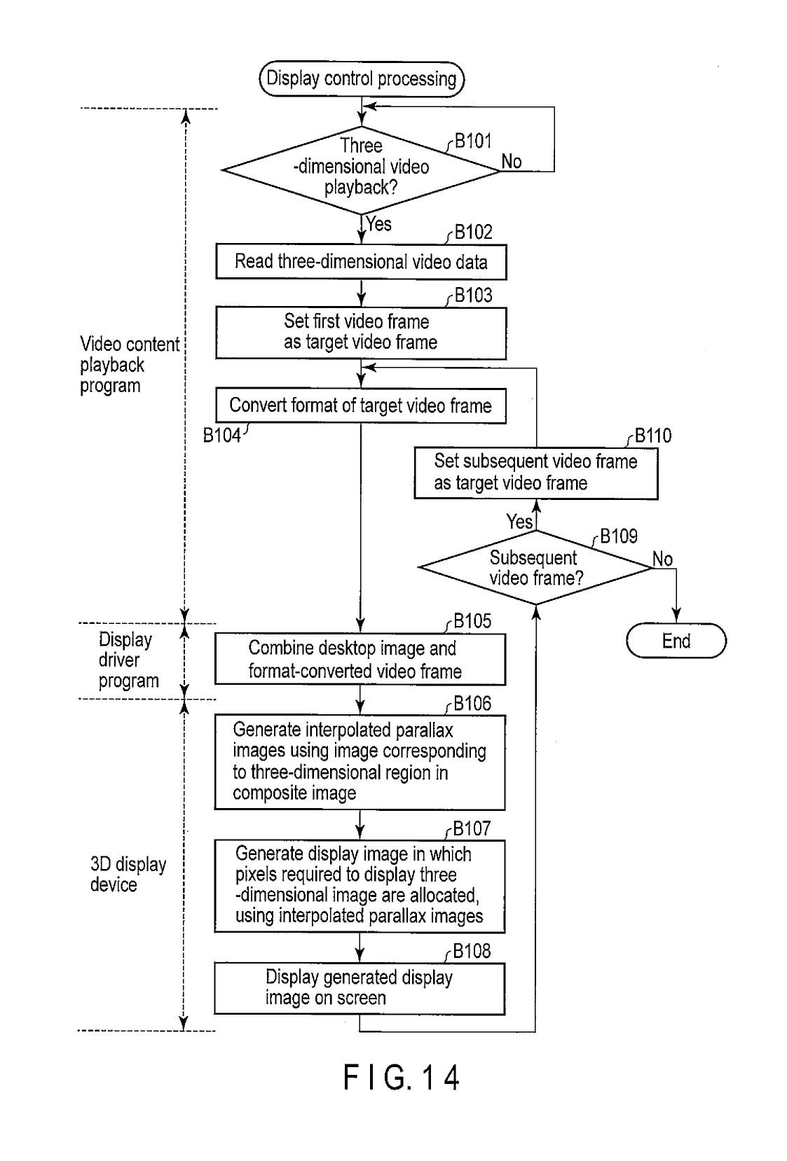

The procedure of display control processing executed by the computer 1 will be described below with reference to the flowchart shown in FIG. 14.

The video reader 131 determines whether a 3D video playback request is detected (block B101). If no 3D video playback request is detected (NO in block B101), the process returns to block B101 to determine again whether or not a 3D video playback request is detected.

If the 3D video playback request is detected (YES in block B101), the video reader 131 reads video content data including 3D video data (block B102). The 3D video data corresponds to, for example, a plurality of video frames. In each of the plurality of video frames, parallax images at two viewpoints (for example, left- and right-eye images) are juxtaposed in the first format (for example, the side-by-side format or top-and-bottom format). Note that each of the plurality of video frames may be an image in which parallax images corresponding to a larger number of viewpoints are laid out (such as an image in which parallax images at four viewpoints are laid out).

The video reader 131 sets a first video frame in the plurality of video frames in the 3D video data as a target video frame (block B103). Then, the format converter 132 converts the format of the target video frame (block B104). For example, the format converter 132 converts the target video frame in the first format into that in the second format (for example, the interleaved format). The format converter 132 detects, for example, left- and right-eye images included in the target frame, and generates a video frame in which pixel lines corresponding to the left-eye image and pixel lines corresponding to the right-eye image are alternately allocated as that in the second format.

Next, the video composite module 134 generates a composite video frame by combining 2D video such as a desktop image generated by the OS 13A (2D video generator 133) and the format-converted video frame (block B105). The 2D video include images of a background, icons, taskbar, toolbar, dialog box, window corresponding to a running application, and the like, which are displayed on the screen. The 2D video further includes the 2D video object such as the cursor, which indicates a position pointed by the pointing device 27. The video composite module 134 combines, for example, the 2D video and the format-converted video frame. Then, the video composite module 134 superimposes the 2D video object on the composite video.

The image interpolation module 151 generates interpolated parallax images using the video corresponding to the 3D video display region 52 in the composite video frame (block B106). More specifically, for example, the image interpolation module 151 detects pixel lines corresponding to the left-eye image and those corresponding to the right-eye image from the video corresponding to the 3D video display region 52. The 2D video object (a part of the 2D video object) superimposed on the pixel lines corresponding to the left-eye image and those corresponding to the right-eye image are also detected while being regarded as the pixel lines corresponding to the left-eye image and those corresponding to the right-eye image. The image interpolation module 151 generates a left-eye image (first parallax image) for displaying a 3D video on the 3D display device 15 using the pixel lines corresponding to the left-eye image (first image), and generates a right-eye image (second parallax image) for displaying a 3D video on the 3D display device 15 using the pixel lines corresponding to the right-eye image (second image).

Then, the display image generator 152 generates a display image in which pixels are allocated according to the pixel (sub-pixel) allocation of the 3D display device 15 using the video corresponding to the 2D video display region 51 in the composite video frame and the generated parallax images (first and second parallax images) (block B107). More specifically, the display image generator 152 allocates pixels in the video corresponding to the 2D video display region 51 in corresponding regions in the display image. Then, the display image generator 152 allocates pixels in the left-eye image (first parallax image) and pixels in the right-eye image (second parallax image) in a predetermined pattern (a pattern required to display a 3D video). Then, the LCD 15A displays the generated display image on the screen (block B108).

The video reader 131 then determines whether or not the subsequent video frame of the target video frame remains (block B109). If the subsequent video frame remains (YES in block B109), the video reader 131 sets the subsequent video frame as a new target video frame (block B110), and the processes in block B104 and subsequent blocks are applied to the newly set target video frame. If no subsequent video frame remains (NO in block B109), the processing ends.

As described above, according to this embodiment, the user can appropriately recognize the 2D video object displayed on a 3D video. The format converter 132 converts a video frame in the first format (for example, the side-by-side format or top-and-bottom format) included in 3D video data into that in the second format (for example, the interleaved format). When the video frame is converted into the second format, the 2D video object such as the cursor, which is rendered on the video frame for the 3D video, can be displayed at an appropriate position on the 3D display device 15 to have an appropriate size. Thus, the user can appropriately recognize and use the 2D video object 541 such as the cursor even in the 3D video display region 52 on the 3D display device 15.

Note that the procedure of the display control processing of this embodiment can be fully implemented by software. For this reason, by installing and executing a program required to implement the procedure of the display control processing in a normal computer via a computer-readable storage medium storing that program, the same effects as in this embodiment can be easily attained.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a format converter configured to convert three-dimensional video data comprising a video frame of a first format to a video frame of a second format, the video frame of the first format comprising images with a first resolution;
a video composite module configured to generate a composite video frame by superimposing a two-dimensional video object on the video frame of the second format;
a parallax image generator configured to generate parallax images with a second resolution higher than the first resolution using the composite video frame; and
a display image generator configured to generate a display image by allocating pixels in the generated parallax images in a first pattern.

2. The electronic apparatus of claim 1, wherein the video frame of the first format comprises two regions in which a first image and a second image are allocated, and
the video frame of the second format comprises first pixel lines corresponding to the first image and second pixel lines corresponding to the second image, the first pixel lines and the second pixel lines allocated alternately.

3. The electronic apparatus of claim 2, wherein the parallax image generator is configured to generate a first parallax image with the second resolution and a second parallax image with the second resolution using the composite video frame, and
the display image generator is configured to generate the display image by allocating pixels in the first parallax image and pixels in the second parallax image in the first pattern.

4. The electronic apparatus of claim 1, wherein the video frame of the first format comprises two regions in which a first image and a second image are allocated, and
the video frame of the second format comprises first pixels in the first image and second pixels in the second image, the first pixels and the second pixels allocated in a grid pattern.

5. The electronic apparatus of claim 4, wherein the parallax image generator is configured to generate a first parallax image with the second resolution and a second parallax image with the second resolution using the composite video frame, and
the display image generator is configured to generate the display image by allocating pixels in the first parallax image and pixels in the second parallax image in the first pattern.

6. The electronic apparatus of claim 1, wherein the two-dimensional video object comprises a cursor configured to indicate a position pointed by a pointing device.

7. The electronic apparatus of claim 1, wherein the two-dimensional video object comprises a window.

8. The electronic apparatus of claim 1, further comprising a display controller configured to control displaying of the display image on a screen.

9. The electronic apparatus of claim 8, further comprising a lens unit comprising lenses for emitting light rays corresponding to pixels in the display image in first directions.

10. A display control method comprising:
converting three-dimensional video data comprising a video frame of a first format to a video frame of a second format, the video frame of the first format comprising images with a first resolution;
generating a composite video frame by superimposing a two-dimensional video object on the video frame of the second format;
generating parallax images with a second resolution higher than the first resolution using the composite video frame; and
generating a display image by allocating pixels in the generated parallax images in a first pattern.

11. A computer-readable, non-transitory storage medium having stored thereon a computer program which is executable by a computer, the computer program controlling the computer to execute functions of:
converting three-dimensional video data comprising a video frame of a first format to a video frame of a second format, the video frame of the first format comprising images with a first resolution;
generating a composite video frame by superimposing a two-dimensional video object on the video frame of the second format;
generating parallax images with a second resolution higher than the first resolution using the composite video frame; and
generating a display image by allocating pixels in the generated parallax images in a first pattern.
